(19) United States
(12) Patent Application Publication
(10) Pub. No.: US 2007/0137112 A1
(43) Pub. Date: Jun. 21, 2007

(54) Door weather strip

(75) Inventors: Hidenori Furuzawa, Aichi-ken (JP); Yoshitaka Sugiyama, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Toyoda Gosei Co., Ltd., Aichi-ken (JP)

(21) Appl. No.: 11/607,104

(22) Filed: Dec. 1, 2006

(30) Foreign Application Priority Data
Dec. 2, 2005 (JP) 2005-349783

(51) Int. Cl. E06B 7/16

(52) U.S. Cl. 49/489.1; 49/498.1

(57) ABSTRACT

A door weather strip for sealing a gap between a door of a motor vehicle and a door opening portion of a vehicle body has an outside strip portion, an inside strip portion and a connection portion for integrally connecting the outside strip portion and the inside strip portion to each other. The outside strip portion has a base part for attachment to an inside part of a retainer, and a seal part. The seal part has a seal wall and a connection wall. The seal wall curves outwardly into an arc-shaped cross-section, a lower end of the seal wall contacts a rear face of an outside end of a door molding, and when the door is closed, the seal wall turns about the base part, and moves toward a bottom of the retainer while sliding on the rear face of the outside end of the door molding.

### CROSS-REFERENCE TO RELATED APPLICATION

This application is related to and claims priority from Japanese patent application No. 2005-349783, incorporated herein by reference.

### BACKGROUND OF THE INVENTION

1. Field of the Invention

The present invention relates to a door weather strip for sealing a gap between a door of a motor vehicle and a door opening portion of a vehicle body.

2. Description of Related Art

As shown in FIG. 1, a gap between a door 10 and a door opening portion 12 of a vehicle body is sealed with a door weather strip 14 which is attached to an outer periphery of a door frame 16 of the door 10, and/or an opening weather strip 18 which is attached to a flange 20 projecting from the door opening portion 12. A gap between a door glass 22 and the door 10 is sealed with a door glass run 24 which is attached in a channel 26 secured to an inner periphery of the door frame 16.

The door glass run 24 has a generally U-shaped cross-section, and includes side walls 28 and 30 and a bottom wall 32. Seal lips 34 and 36 project from open ends of the side walls 28 and 30 for contacting and sealing the door glass 22.

The opening weather strip 18 is attached to the flange 20 provided in the door opening portion 12 with a trim portion 38 having a generally U-shaped cross-section, and when the door 10 is closed, the door frame 16 contacts a tubular seal portion 40 to seal a gap between the door 10 and the door opening portion 12.

The door weather strip 14 includes a base portion 42, a tubular seal 44 and a seal lip 46. The tubular seal 44 and the seal lip 46 are formed on the upper side of the base portion 42 integrally therewith. The base portion 42 is fitted in a retainer 48 secured to the outer periphery of the door frame 16. When the door 10 is closed, the seal lip 46 contacts the door opening portion 12 to seal the gap between the door frame 16 and an outside end of the door opening portion 12. And the tubular seal 44 contacts the door opening portion 12 on the inner side of the contacting position of the seal lip 46 to seal the gap between the door 10 and the door opening portion 12.

When the door 10 is closed, the seal lip 46 is pressed by a peripheral edge of the door frame 16 against the door opening portion 12, and consequently, the seal lip 46 is bent to form a depression therein to degrade the appearance thereof.

When the motor vehicle is running at high speeds, the door 10 may be drawn and displaced outwardly due to pressure differences between the interior and the exterior of the vehicle body, etc. Consequently, the seal lip 46 may detach from the door opening portion 12 and a tip end thereof may protrude outwardly of the vehicle body to degrade the sealing properties.

As shown in FIG. 2, in order to make the door opening portion 12 and the door frame 16 flush with each other without forming any depression therebetween, thereby improving the appearance around the door frame 16, and in order to prevent the tip end of the seal lip from being drawn outwardly upon running of the motor vehicle at high speeds, there has been proposed to provide a seal lip 50 having a generally hook-shaped cross-section (see Publication of Japanese Utility Model application No. Hei 3-10922, etc.).

The seal lip 50 having a generally hook-shaped cross-section, however, may have the following problem. Namely, when the door 10 is opened and closed, a tip end of the seal lip 50 may displace in a width direction of the vehicle body. When the door 10 is closed, and a middle part of the seal lip 50 contacts a roof molding 52 attached along a roof-side of the door opening portion 12, the seal lip 50 may be deformed to form depressions and projections between the door frame 16 and the roof molding 52, and the tip end of the seal lip 50 may detach from the door frame 16 and protrude outwardly of the vehicle body. At this time, a base of the seal lip 50 may be also deformed, whereby the seal lip 50 detach from the door opening portion 12 to degrade the sealing properties thereof.

Alternatively, as shown in FIG. 3, a tubular seal part 54 may be substituted for the seal lip shown in FIG. 2 (see Publication of unexamined Japanese Patent application No. Hei 11-34672, ex.).

However, in this case, the following problem may occur. Namely, when the door 10 is closed, and the tubular seal part 54 contacts the door opening portion 12, the tubular seal part 54 may be collapsed, and consequently, the door closing force may be increased. In addition, an outside wall of the tubular seal part 54 may protrude outwardly of the door opening portion 12 and the door frame 16 to degrade the appearance.

Recently, hidden type doors have been frequently used to meet demands for motor vehicles with good design. As shown in FIG. 4, in a hidden type door 10, the width of a vertical wall provided along the outside end of a door frame 16 is made small to decrease the gap between the door 10 and the door opening portion 12. The hidden type door 10 has the door frame 64 which is narrow in width, and is covered with a door molding 68 attached to an outer periphery of the door frame 64.

Accordingly, an outside part of a door weather strip 14 need to be made small.

In the door weather strip 14 of FIG. 4, an outside strip portion 56 is made small and a small-sized seal lip 58 is provided therein. And an inside strip portion 60 is attached to an inside part of the door frame 16 downwardly of the outside strip portion 56 (see Publication of unexamined Japanese Patent application No. 2002-307952, ex.).

In this case, a tubular seal part 62 of the inside strip portion 60 can have the dimensions similarly to those of the conventional tubular seal part. However, the seal lip 58 of the outside strip portion 56 is small so that the sealing properties thereof are insufficient. In addition, when the door 10 is closed, the seal lip 58 may protrude outwardly of the door frame 16, and a depression may be formed between the door opening portion 12 and the door frame 16, which is less preferable to effect motor vehicles with good design.

### SUMMARY OF THE INVENTION

Accordingly, it is an object of the present invention to provide a door weather strip for a motor vehicle, which is capable of surely closing a gap between a vehicle door and a door opening portion with a sealing portion thereof, and exhibiting a good appearance and excellent sealing properties without forming any depression and projection.

In accordance with the present invention, the door weather strip for sealing a gap between a vehicle door and a door opening portion of a vehicle body includes an outside strip portion to be attached to an outside part of the door frame for sealing a gap between the door frame and an outside part of the door opening portion of the vehicle body, an inside strip portion to be attached to an inside part of the door frame for sealing a gap between the door frame and an inside part of the door opening portion of the vehicle body, and a connection portion for integrally connecting the outside strip portion and the inside strip portion to each other. The outside strip portion has a base part for attachment to an inside part of a retainer which is secured to the outside part of the door frame, and a seal part for sealing a gap between an outside end of the door opening portion and an outside end of the door frame or a door molding which is attached to the door frame. The seal part has a seal wall for contacting the outside end of the door opening portion and the outside end of the door frame or the door molding, and a connection wall for connecting the seal wall and the base part to each other.

The seal wall of the seal part curves outwardly into an arc-shaped cross-section, one end of the seal wall on the side of the door frame or the door molding contacts a rear face of the outside end of the door frame or the the door molding, and when the door is closed and the other end of the seal wall on the side of the door opening portion contacts the door opening portion, the seal wall turns about the base part, and the one end of the seal wall slides on the rear face of the outside end of the door frame or the door molding and moves toward a bottom of the retainer.

With this arrangement, since the outside strip portion has the base part for attachment to the inside part of the retainer which is secured to the outside part of the door frame, and the seal part for sealing the gap between the outside end of the door opening portion and the outside end of the door frame or the door molding which is attached to the door frame, the base part is held with the inside part of the retainer, and the seal part is turnable about the base part to seal the gap between the door opening portion and the outside end of the door frame.

Since the seal part has the seal wall for contacting the outside end of the door opening portion and the outside end of the door frame or the door molding, and a connection wall for connecting the seal wall and the base part to each other, where the door frame has a vertical wall at an outside end thereof, the seal wall can close a gap between the door frame and the door opening portion, and where a door molding is attached to the door frame, the seal wall can close a gap between the door molding and the door opening portion. In addition, the connection wall can turn about the base part to decrease a door closing force.

Since the seal wall of the seal part curves outwardly into an arc-shaped cross-section, and one end of the seal wall on the side of the door frame or the door molding contacts the rear face of the outside end of the door frame or the door molding, the seal wall can close the gap between the door opening portion and the door frame or the door molding with a flat face without forming any depression therein. In addition, since the one end of the seal wall contacts the rear face of the door frame or the door molding, the seal wall is prevented from protruding outwardly and accordingly a good appearance can be exhibited.

Where the door molding and the retainer are formed integrally with each other, the outside wall of the retainer acts as the above-described rear face of the door molding.

Since, when the door is closed, and the other end of the seal wall on the side of the door opening portion contacts the door opening portion, the seal wall turns about the base part toward a bottom of the retainer while sliding on the rear face of the outside end of the door frame or the door molding, and the seal wall is pushed by the door opening portion to slide while maintaining a good seal between the door opening portion and the door frame or the door molding, whereby sealing properties are improved, and the door closing force can be decreased.

It is preferable that the seal wall of the seal part of the outside strip portion has a lip-shaped configuration, and the seal wall and the connection wall are connected to each other to have an L-shaped or T-shaped cross-section.

With this arrangement, the lip-shaped seal wall can be readily flexed so that, when the door is closed, and the seal wall is greatly pushed by the door opening portion, the seal wall readily deforms while maintaining good sealing properties, thereby decreasing the door closing force.

Since the seal wall is connected to the connection wall into an L-shaped or T-shaped cross-section, where the connection wall is deformed, the outside end of the seal wall can be slid on the rear face of the outside end of the door frame or the door molding. In the case of the L-shaped cross-section, the seal wall exhibits good flexibility, and in the case of the T-shaped cross-section, the position of the outside end of the seal wall is restrained from varying greatly, whereby the end of the seal wall can be securely brought into contact with the rear face of the outside end of the door frame or the door molding.

It is preferable that the seal wall of the seal part of the outside strip portion has a lip-shaped configuration, and the lip-shaped seal wall is connected to the connection wall on the side of the door opening portion.

With this arrangement, when the door is closed, a connecting part of the seal wall and the connection wall is pushed by the door opening portion to flex the connection wall and turn the seal wall, thereby sliding the seal wall on the rear face of the outside end of the door frame or the door molding without forming abnormal deformation of the seal wall.

It is preferable that the seal part of the outside strip portion has a tubular configuration, and the seal wall is connected to the connection wall at both ends thereof, which are located on the side of the door opening portion and on the side of the door frame or the door molding

With this arrangement, the seal wall slides smoothly without protruding outwardly of the door frame or the door molding, thereby effecting good sealing properties without degrading the appearance therearound.

It is preferable that the base part of the outside strip portion is held in contact with an inside end, an inside wall and a bottom wall of the retainer.

With this arrangement, the base part of the outside strip portion can be securely held with the retainer, and the seal part can be securely brought into contact with the rear face of the outside end of the door frame or the door molding.

It is preferable that the base part of the outside strip portion is composed of a hard material.

With this arrangement, the base part can be securely held with the retainer which is attached to the door frame or the door molding, or formed integrally therewith, whereby the outside strip portion can be brought into contact with predetermined positions to ensure sealing properties thereagainst.

It is preferable that the rear face of the outside end of the door frame or the door molding has a space between the one end of the seal wall on the side of the door frame or the door molding and a bottom of the door frame or the retainer for enabling the sliding of the seal wall.

With this arrangement, when the door is closed, and the outside strip portion is pushed by the door opening portion to flex the connection wall of the seal part thereof, the seal wall can readily move while sliding toward the bottom of the door frame or the retainer, thereby decreasing the door closing force.

In accordance with the present invention, the seal wall of the seal part of the outside strip portion is formed into an arc-shaped cross-section, and, upon attaching to the vehicle door, curves outwardly of the vehicle body so as to contact the rear face of the outside end of the door frame or the door molding. Therefore, the seal wall can seal a gap between the door opening portion and the outside end of the door frame or the door molding, and can be prevented from protruding outwardly of the vehicle body to maintain good appearance.

When the door is closed, the seal wall turns about the base part while sliding on the rear face of the outside end of the door frame or the door molding, whereby good sealing of a gap between the door opening portion and the door frame or the door molding is maintained to improve the sealing properties and decrease the door closing force.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a cross-sectional view of a door seal structure including one example of a conventional door weather strip;

FIG. 2 is a cross-sectional view of another example of a conventional door weather strip;

FIG. 3 is a cross-sectional view of a further example of a conventional door weather strip;

FIG. 4 is a cross-sectional view of a still another example of a conventional door weather strip;

FIG. 5 is a side view of a motor vehicle;

FIG. 6 is a cross-sectional view of a first embodiment of a door weather strip in accordance with the present invention, which is taken along the line A-A of FIG. 5; and

FIG. 7 is a cross-sectional view of a second embodiment of a door weather strip in accordance with the present invention;

FIG. 8 is a cross-sectional view of a third embodiment of a door weather strip in accordance with the present invention; and

FIG. 9 is a cross-sectional view of a fourth embodiment of a door weather strip in accordance with the present invention.

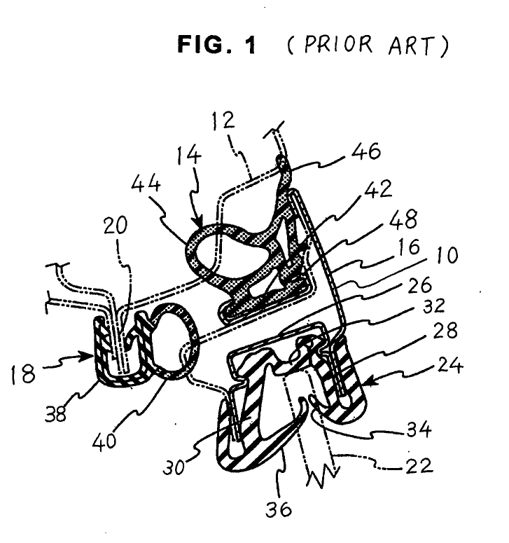

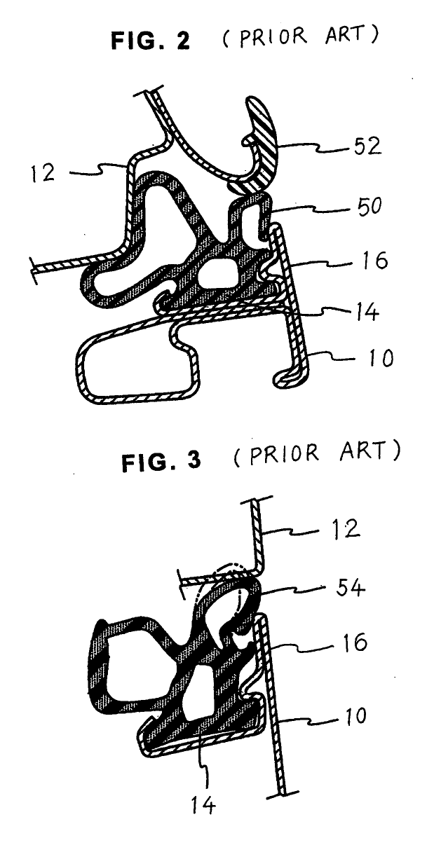

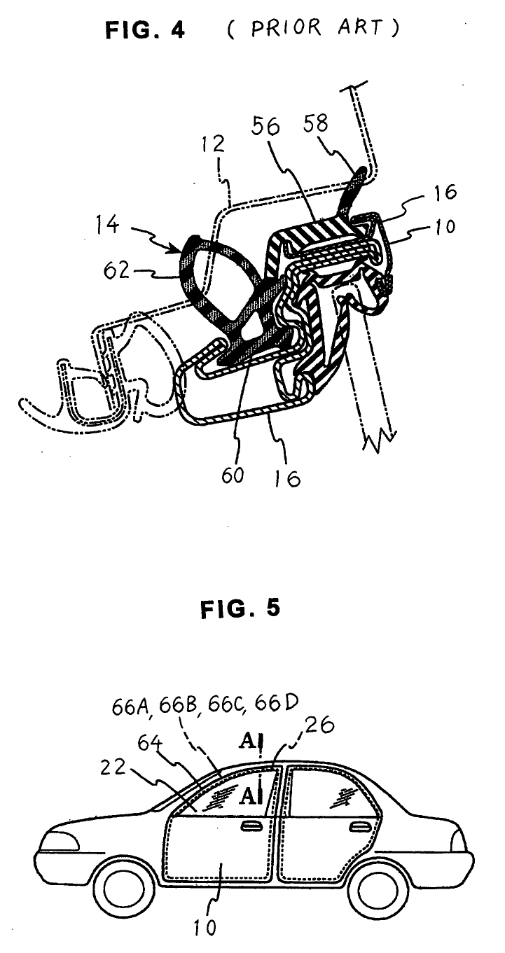

### DETAILED DESCRIPTION OF THE PREFERRED EMBODIMENTS

Embodiments of the present invention will be explained with reference to FIGS. 5 through 9. FIG. 5 is a side view of a motor vehicle. As shown, a door frame 64 extends along a periphery of an upper part of a vehicle door 10, and a door glass 22 is movably mounted in the vehicle door 10. A door weather strip 66A, 66B, 66C or 66D is attached along an outer periphery of the door frame 64 to seal a gap between the vehicle door 10 and a door opening portion 12.

A channel 26 is provided along an inner periphery of the door frame 64, and a glass run is attached in the channel 26 to guide the rising and lowering of the door glass 22 and seal a gap between the door glass 22 and the door frame 64.

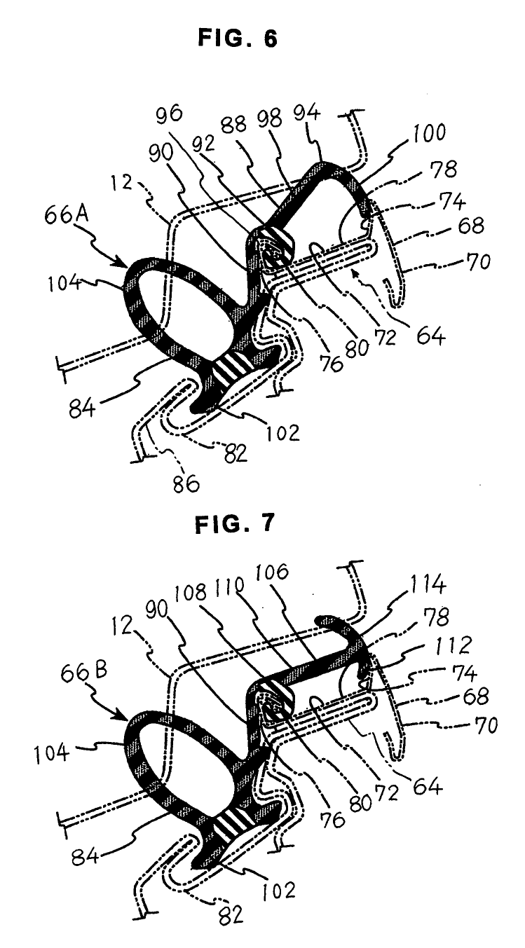

FIGS. 6 through 9 are cross-sectional views of embodiments of the door weather strip in accordance with the present invention, which are taken along line A-A of FIG. 5, and respectively show the attaching state of the door weather strip to the vehicle door.

Straight sections of the door weather strip are formed by an extrusion-molding into a strip-shaped configuration, and curved sections adapted to be attached to corners of the door frame 16 are formed by an injection-molding.

A first embodiment of the present invention will be explained with reference to FIG. 6. As shown, in the present embodiment, a door weather strip 66A is attached to a door frame 64 of a hidden type. The door frame 64 is narrow in width, and is covered with a door molding 68 which is attached to an outer periphery of the door frame 64. The door molding 68 includes a molding section 70 and a retainer section 72 which is formed integrally with the molding section 70. The molding section 70 and the retainer section 72 may be formed separately from each other.

Where the door frame is not the hidden type door frame, the retainer section is formed separately from the molding section, and an outside end of the door frame is extended vertically with a great width, similarly to the molding section 70. In this case, the retainer section is secured to a rear face of the vertically extended outside end of the door frame.

The molding section 70 has a predetermined width capable of covering an outside end of the door frame 64, and a lower end of the molding section 70 bends upwardly into a hair pin-shaped configuration. The hair pin-shaped bending part of the molding section 70 holds a glass run (not shown) along with a lower face of the door frame 64.

An upper end of the molding section 70 bends downwardly into a hair pin-shaped configuration and is connected to the retainer section 72 integrally. The molding section 70 and the retainer section 72 can be formed by bending a piece of metallic plate.

The retainer section 72 is formed to have a generally U-shaped cross-section, and includes an outside wall 74 which is connected to the molding section 70 integrally, an inside wall 76 and a bottom wall 78. An end 80 of the inside wall 76 bends into a hook-shaped configuration.

The outer periphery of the door frame 64 is formed into a stepped configuration such that an inside half thereof is lower than an outside half thereof. And a retainer-shaped groove 82 is formed in the inside half of the outer periphery of the door frame 64 for enabling the attachment of a later describing inside strip portion 84. The retainer-shaped groove 82 is defined by bending an inner panel 86 of the door frame 64.

As shown in FIG. 6, the door weather strip 66A includes the inside strip portion 84, an outside strip portion 88 and a connection portion 90 which integrally connects the inside strip portion 84 and the outside strip portion 88 to each other.

The outside strip portion 88 is attached to the retainer section 72 of the door frame 64 to seal a gap between the outer periphery of the door frame 64 and a facing door opening portion 12.

The inside strip portion 84 is attached to the retainer-shaped groove 82 of the door frame 64 to seal the gap between the outer periphery of the door frame 64 and the facing door opening portion 12 on the inside of the outside strip portion 88. Thus, the outside strip portion 88 and the inside strip portion 84 provide a double seal between the outer periphery of the door frame 64 and the facing door opening portion 12.

The outside strip portion 88 has a base part 92 and a seal part 94. The base part 92 has a hook-shaped cross-section, and a space 96 is defined in a widthwise center thereof. When the door weather strip 66A is attached to the door frame 64, the end 80 of the inside wall 76 of the retainer section 72 is fitted in the space 96 of the base part 92. The base part 92 of the outside strip portion 92 contacts the bottom wall 78 and the inside wall 76 inclusive of the end 80 thereof and is held therewith. Consequently, the seal part 94 can be held in position, whereby the seal part 94 can be brought into contact with the door molding 68 and the door opening portion 12 to securely close a gap therebetween.

The base part 92 of the outside strip portion 88 can be composed of a hard material. Where the base part 92 is composed of the hard material, the base part 92 can be strongly attached to the inside wall 76 of the retainer section 72, whereby the seal part 94 can be held in position to ensure good sealing properties.

Examples of the hard material includes a hard rubber with JIS hardness of 850°˜950°. Where the hard rubber is used, the base part 92 can be molded simultaneously with other parts composed of a soft rubber.

Where a hard material of EPDM rubber or thermoplastic olefine elastomer is used, obtained products exhibit good weather resistance.

The seal part 94 includes a connection wall 98 and a seal wall 100. The connection wall 98 is formed to have a plate-shaped configuration, and one end of the connection wall 98 is formed integrally with the base part 92 so as to be continuous with the connection portion 90. The other end of the connection wall 98 is formed integrally with the seal wall 100.

The seal wall 100 is formed into a lip-shaped configuration and extends outwardly to have an arc-shaped cross-section. The connection wall 98 is integrally connected to a base end of the seal wall 100, which is located on the side of the door opening portion 12. Thus, the seal part 94 has a generally L-shaped cross-section, and can close and seal the gap between the door opening portion 12 and the door molding 68 which is attached to the door frame 64 in substantially flush with an outside face of the door molding 68 without forming any depression in the seal wall 100.

A tip end of the seal wall 100 contacts the outside wall 74 of the retainer section 72, as a rear face of the molding section 70 of the door molding 68. Consequently, the tip end of the seal wall 100 is prevented from coming off the retainer section 72 to protrude outwardly, whereby good appearance can be maintained.

When the door is closed, the base end of the seal wall 100, which is integrally connected to the connection wall 98, contacts the door opening portion 12, and is pushed thereby. Consequently, the connection wall 98 is deformed and the tip end of the seal wall 100 slides on the outside wall 74 of the retainer section 72 toward the bottom wall 78.

Where the door frame is not the hidden type, the seal wall of the outside strip portion contacts a rear face of a vertical wall provided in an outside end of the door frame, and the tip end of the seal wall slides thereon.

In the present embodiment, a space is defined between the tip end of the seal wall 100 and the bottom wall 78 so as to enable the sliding of the tip end of the seal wall 100. With this arrangement, when the door is closed, the seal wall 100 can readily slide and move toward the bottom wall 78, thereby enabling the reduction of the door closing force.

The seal part 94 of the outside strip portion 88, the connecting portion 90, a later describing seal part of the inside strip portion 84, and outside and inside ends of a base part thereof are composed of a sponge material of EPDM rubber or thermoplastic olefine elastomer, whereas the remaining portions are composed of a hard material. Where the hard material is composed of EPDM rubber or thermoplastic olefine elastomer, the door weather strip 66A is entirely composed of olefine materials. In this case, the door weather strip 66A can be pulverized together for recycling.

The inside strip portion 84 includes a base part 102 and a seal part 104.

The base part 102 has a generally plate-shaped configuration, the outside and inside ends thereof are respectively fit in the retainer-shaped groove 82 to hold the inside strip portion 84. A widthwise center of the base part 102 is composed of a hard material to prevent the door weather strip 66A from meandering upon extrusion and vulcanization.

The seal part 104 is formed tubular. When the door is closed, the seal part 104 contacts a projection provided in the door opening portion 12 to effect a seal between the door opening portion 12 and the door frame 64.

The retainer-shaped groove 82 is provided downwardly of the retainer section 72 of the door frame 64. With this arrangement, though the tubular seal section 104 is made to have great dimensions, the gap between the door opening portion 12 and the door frame 64 can be reduced.

The connection portion 90 extends from the inside seal part 104 and is connected to the base part 92 of the outside strip section 88 integrally.

A second embodiment of the present invention will be explained with reference to FIG. 7. The second embodiment differs from the first embodiment in configuration of the seal part of the outside strip portion of the door weather strip, but the remaining portions of the second embodiment are similar to those of the first embodiment. Therefore, only the differences between the first embodiment and the second embodiment will be explained, and explanations of similar constructions will be omitted.

As shown in FIG. 7, a plate-shaped connection wall 106 of a door weather strip 66B extends from a base part 108 of an outside strip portion 110, and a lip-shaped seal wall 112 of a seal part 114 is integrally provided at an end of the connection wall 106 into a T-shaped cross-section such that the width of an upper half of the seal wall 112 is greater than that of a lower half thereof. The seal wall 112 curves outwardly to have an arc-shaped cross-section. Since the lower half of the seal wall 112 is made shorter, variations of the position of a lower end of the seal wall 112 can be reduced, whereby the lower end of the seal wall 112 can be securely brought into contact with the outside wall 74 of the retainer section 72.

When the door is closed, an upper end of the seal wall 112 contacts the door opening portion 12 to effect a seal between the door opening portion 12 and the door frame 16. At this time, the upper half of the seal wall 112 is pushed by the door opening portion 12 to be readily flexed, and the connection wall 106 is flexed to turn the seal part 114 downwardly. Thus, when the door is closed, the upper half of the seal wall 112 can be flexed, thereby ensuring sealing properties of the seal wall 112 and reducing the door closing force.

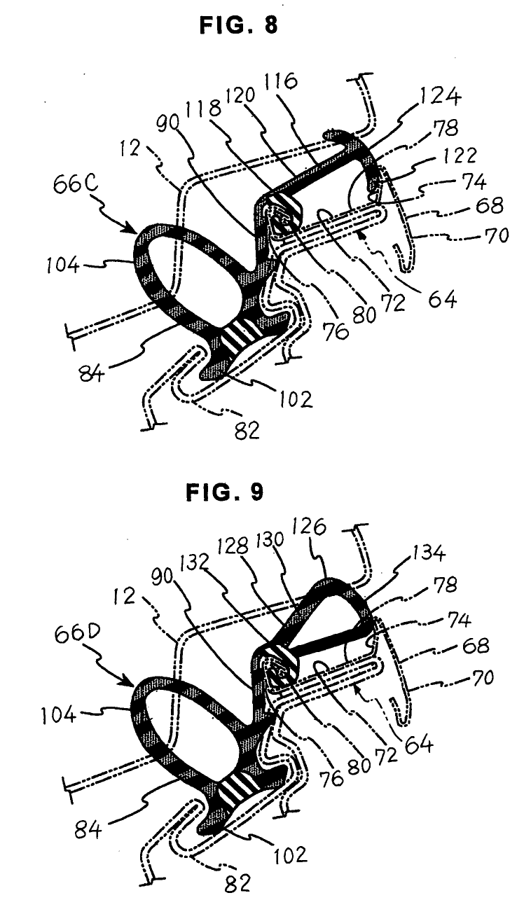

A third embodiment of the present invention will be explained with reference to FIG. 8. The third embodiment differs from the second embodiment in configuration of the seal part of the outside strip portion of the door weather strip, but the remaining portions of the third embodiment are similar to those of the second embodiment. Therefore, only the differences between the second embodiment and the third embodiment will be explained, and explanations of similar constructions will be omitted.

As shown in FIG. 8, a plate-shaped connection wall 116 of a door weather strip 66C extends from a base part 118 of the outside strip portion 120, and a lip-shaped seal wall 122 of a seal part 124 is integrally connected to the connection wall 116 into a T-shaped cross-section such that the width of an upper half of the seal wall 122 is less than that of a lower half thereof.

Since the lower half of the seal wall 122 is made longer, the lower half of the seal wall 122 is readily flexed to facilitate the turning of the seal wall 122 while contacting the outside wall 74 of the retainer section 72 when the door is closed, and the seal wall 122 slides on the outside wall 74.

Since the upper half of the seal wall 122 is made shorter, the upper half of the seal wall 122 is prevented from protruding outwardly of the door opening portion 12 when the door is closed. In addition, when the door is closed, the upper half of the seal wall 122 is pushed by the door opening portion 12 to securely flex the connection wall 116, and securely slide the lower end of the seal wall 122 on the outside wall 74 of the retainer section 72.

A fourth embodiment of the present invention will be explained with reference to FIG. 9. The fourth embodiment differs from the first embodiment in configuration of the seal part of the outside strip portion of the door weather strip, but the remaining portions of the fourth embodiment are similar to those of the first embodiment. Therefore, only the differences between the first embodiment and the fourth embodiment will be explained, and explanations of similar constructions will be omitted.

As shown in FIG. 9, a seal part 126 of an outside strip portion 128 of a door weather strip 66D has a tubular configuration. Two connection walls 130 extend from a base part 132 of the outside strip portion 128, and ends of a lip-shaped seal wall 134 are integrally connected to extending ends of the connection walls 130 to form a tubular cross-section.

The seal wall 134 curves outwardly to have an arc-shaped cross-section. A lower end of the seal wall 134 contacts the outside wall 74 of the retainer section 72. A space is defined between the lower end of the seal wall 134 and the bottom wall 78 so as to enable the sliding of the lower end of the seal wall 134 on the outside wall 74. Since the ends of the seal wall 134 are connected to the connection walls 130, the seal wall 134 does not protrude outwardly of the door opening portion 12 and the door molding 68 of the molding section 70 when the door is closed, thereby maintaining good appearance therearound.

When the door is closed, an upper end of the seal wall 134 contacts the door opening portion 12, whereas a lower end of the seal wall 134 contacts the outside wall 74 of the retainer section 72 to close the gap between the door opening portion 12 and the door frame 64 with a flat face, thereby sealing the same. At this time, the connection walls 130 are flexed about the base part 132, thereby ensuring a seal between the door opening portion 12 and the door frame 64.

Hereinafter, the producing method of the door weather strips 66A, 66B, 66C and 66D will be explained.

Straight sections of the door weather strips 66A through 66D are composed of synthetic rubber such as EPDM rubber, etc., thermoplastic elastomer such as polyolefine-based elastomer, etc., or soft synthetic resin such as soft vinyl chloride, etc. It is preferable that these materials are foamed into sponge-shaped materials for improving the flexibility of the straight sections of the door weather strips 66A through 66D.

In the case of synthetic rubber, after extrusion, the straight sections are transferred to a vulcanizing chamber, and heated by the normally available method to carry out vulcanization and foaming of the synthetic rubber. Then, the obtained straight sections are cut to have desired lengths. Thus, the extruded portions are produced.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A door weather strip to be attached to an outer periphery of a door frame of a door of a motor vehicle for sealing a gap between the door and a door opening portion of a vehicle body comprising:
an outside strip portion to be attached to an outside part of the door frame for sealing a gap between the door frame and an outside part of the door opening portion of the vehicle body;
an inside strip portion to be attached to an inside part of the door frame for sealing a gap between the door frame and an inside part of the door opening portion of the vehicle body; and
a connection portion for integrally connecting said outside strip portion and said inside strip portion to each other;
said outside strip portion having a base part for attachment to an inside part of a retainer which is provided in said outside part of the door frame, and a seal part for sealing a gap between an outside end of the door opening portion and an outside end of one of the door frame and a door molding which is attached to the door frame, said seal part having a seal wall for contacting said outside end of the door opening portion and said outside end of one of the door frame and said door molding, and a connection wall for connecting said seal wall and said base part to each other;
said seal wall curving outwardly into an arc-shaped cross-section, one end of said seal wall on the side of one of the door frame and said door molding contacting a rear face of said outside end of one of the door frame and said door molding, and when the door is closed and the other end of said seal wall on the side of the door opening portion contacts the door opening portion, said seal wall turns about said base part, and said one end of said seal wall slides on said rear face of said outside end of one of the door frame and said door molding and moves toward a bottom of said retainer.

2. A door weather strip as claimed in claim 1, wherein said seal wall of said seal part of said outside strip portion has a lip-shaped configuration, and said seal wall is connected to said connection wall to have one of an L-shaped cross-section and a T-shaped cross-section.

3. A door weather strip as claimed in claim 1, wherein said seal wall of said seal part of said outside strip portion has a lip-shaped configuration, and said seal wall is connected to said connection wall on the side of the door opening portion.

4. A door weather strip as claimed in claim 1, wherein said seal part of said outside strip portion has a tubular configuration, and said seal wall is connected to said connection wall at both ends thereof, which are to be located on the side of the door opening portion and on the side of one of the door frame and said door molding.

5. A door weather strip as claimed in claim 1, wherein said base part of said outside strip portion is held in contact with an inside end, an inside wall and a bottom wall of said retainer.

6. A door weather strip as claimed in one of claim 1, wherein said base part of said outside strip portion is composed of a hard material.

7. A door weather strip as claimed in claim 1, wherein said rear face of said outside end of one of the door frame and said door molding has a space between said one end of said seal wall on the side of one of the door frame and said door molding and a bottom of one of the door frame and said retainer for enabling the sliding of said seal wall.
